(19) United States
(12) Patent Application Publication
(10) Pub. No.: US 2016/0131444 A1
(43) Pub. Date: May 12, 2016

(54) HEAT EXCHANGE STRUCTURE, METHOD FOR PRODUCING SAME, HEAT EXCHANGE DEVICE COMPRISING SUCH A STRUCTURE AND USES OF SAME

(71) Applicants: COMMISSARIAT Á L'ÉNERGIE ATOMIQUE ET AUX ÉNERGIES ALTERNATIVES, Paris (FR); UNIVERSITE JOSEPH FOURIER, Grenoble Cedex 09 (FR)

(72) Inventors: Jean-Antoine GRUSS, Seyssinet (FR); Remi Bertossi, Poitiers (FR); Nadia Caney, Le Fontanil (FR); Philippe Marty, Saint Martin D'uriage (FR); Olivier Poncelet, Grenoble (FR); Antoine Voirand, Chasseneuil (FR)

(21) Appl. No.: 14/898,082

(22) PCT Filed: Jun. 13, 2014
(86) PCT No.: PCT/EP2014/062436

§ 371 Date: Dec. 11, 2015

(30) Foreign Application Priority Data
Jun. 14, 2013 (FR) 13 55574

(51) Int. Cl. F28F 13/18; B23P 15/26

(52) U.S. Cl. CPC F28F 13/18; B23P 15/26

(57) ABSTRACT

A heat exchange structure, and an assembly as well as to a heat exchange device comprising such a structure, applying heat transfer by boiling of a liquid and comprising a substrate and at least one layer intended to be in contact with a liquid and at least partly positioned on the substrate. The composition of this layer comprises at least a molecular switch having a lower critical solubility temperature T_{LCST} above which it gives the layer non-wetting properties towards the liquid and below which it gives the layer wetting properties towards the liquid, this lower critical solubility temperature T_{LCST} of the molecular switch being selected so as to be greater than or equal to the saturation temperature Tₛₐₜ of the liquid.

### TECHNICAL FIELD

The present invention relates to a heat exchange structure, to a heat exchange device, in particular by boiling of a fluid, comprising such a structure, for example a boiler, a diphasic thermosiphon or a heat pipe, as well as to the uses of this structure and of this device.

The present invention also relates to a method for manufacturing such a heat exchange structure.

### STATE OF THE PRIOR ART

The energy efficiency of heat exchange devices mainly lies in the improvement of performances of the heat exchange surfaces which make them up.

In the case of heat exchange devices applying liquid/vapor diphasic flows, the distribution of the phases in the device may be a source of deterioration of the heat transfers, whether these transfers are carried out by condensation, by evaporation or by boiling.

Within the scope of the present invention, we will more particularly examine heat exchange devices which apply heat transfer by boiling.

Such devices include a heat exchange structure which has a heat exchange surface at which the liquid, in contact with said surface, is subject to a phase transition by evaporation. Under the effect of the temperature of this surface, the boiling cycle of the liquid will be established: bubbles form from nucleation sites present on this surface, and then grow and finally are detached from the heat exchange surface.

It is known that by applying wetting heat exchange surfaces, it is possible to obtain good heat transfer performances. Indeed, because of the low contact angle (typically less than 90°) between the sphere portion of the bubbles in contact with the wetting surface, good transfer of heat from the surface to the bubbles as well as easy detachment of the bubbles from this surface are observed, thus ensuring a high frequency of bubble emission. On the other hand, the wetting heat exchange surfaces do not give the possibility of obtaining sufficiently numerous and active nucleation sites for ensuring the formation of bubbles. In order to find a remedy to this, it becomes necessary to increase the temperature of the heat exchange surface in order to regenerate the conditions required for forming these bubbles. Such an increase may lead to overheating of this heat exchange surface and consequently to degradation of the heat exchange coefficient.

On the contrary, the formation or nucleation of bubbles is promoted by applying a non-wetting heat exchange surface. The contact angle formed by the sphere portion of these bubbles in contact with this surface is then high, typically greater than or equal to 90°. However, the bubbles formed at a non-wetting surface tend to coalesce and not being easily detached from this surface, they have a low emission frequency. The application of a non-wetting heat exchange surface is therefore not favorable by itself to good heat transfer.

It is therefore observed that the boiling cycle is subject to antagonistic effects depending on the wetting or non-wetting properties which the heat exchange surface has.

In order to find a remedy to these antagonistic effects and therefore to improve the heat transfer by boiling, making heterogeneous heat exchange surfaces has been proposed, in that they have wetting and non-wetting properties. Such surfaces thus comprise non-wetting sites, promoting nucleation of the bubbles, these surfaces being moreover globally wetting in order to promote growth and detachment of the bubbles and therefore heat transfer.

In this respect, it is possible to refer to document EP 2 028 432 A1 which describes a heat exchanger comprising at least one hydrophilic (wetting) heat exchange surface in contact with a coolant fluid. This hydrophilic surface has a surface roughness of less than 1 μm and comprises for controlling the triggering of the boiling:

at least one discrete area (or nucleation site) on which are covalently grafted hydrophobic (non-wetting) molecules, or

at least one discrete area (or nucleation site) coated with a hydrophobic (non-wetting) polymer.

Document WO 2010/012798 A1 also describes a heat exchange structure having a heterogeneous heat exchange surface. This heterogeneous heat exchange surface includes, positioned on a substrate, a nanometric structure covering a micrometric structure formed with cavities, the inner surface of which has non-wetting properties. The inter-cavity area, as for it exhibits wetting properties and the proportion of non-wetting surface relatively to the total surface is low, advantageously less than about 15%. The inner surface of the cavities is therefore favorable to the formation of bubbles, these cavities being bordered with a surface facilitating detachment of the bubbles.

If the heat exchange surfaces described in the documents mentioned above prove to be satisfactory in terms of efficiency and give the possibility of obtaining good heat transfer, nevertheless it remains that they are relatively complex to make, notably because of their heterogeneity. In particular, the chemical heterogeneity obtained by producing non-wetting discrete areas on a wetting surface as described in document EP 2 028 432 A1, just like the geometrical and chemical heterogeneity obtained by making cavities provided with non-wetting properties for obtaining the heat exchange structure described in document WO 2010/012798 A1 are real industrial constraints.

In particular, in document WO 2010/012798 A1, the micrometric structure is made by successive depositions on the substrate of a sacrificial layer, of a hard mask and of a photo-resin layer. Cavities are then made in these three layers. And then, after removing the residual photo-resin layer, it is proceeded with the deposition of nanoparticles, notably metal or metal alloy nanoparticles, and then with the deposition of a film in a hydrophobic material before achieving a hydrophilic treatment of the inter-cavity area. Some of the steps which have just been mentioned are applied by techniques which are limits in terms of shape, of size and/or of material of the substrate to be treated. Typically, the sacrificial layer, the hard mask and the film in a hydrophobic material are produced by plasma enhanced chemical vapor deposition or PECVD while the nanoparticles are subject to metal organic chemical vapor deposition or MOCVD. These PECVD and MOCVD methods can only be applied on substrates which have an open surface and which are applied with a limited size (less than 25×25 cm²). Furthermore, these methods may apply high temperatures (of the order of 300 to 800° C.) to which any type of substrates, notably those in polymer(s), does not resist.

Such industrial constraints are moreover even more difficult to surmount when the heat exchange surfaces are intended to equip non-open heat exchange structures, such as tubes.

The object of the invention is for example to overcome the drawbacks of the prior art and to propose heat exchange surfaces by boiling which give the possibility of ensuring good heat transfer and this:

regardless of the material of the substrate which enters the composition of the heat exchange structure, this substrate may equally be in metal, in polymer(s) or further in a composite or ceramic material,

regardless of the shape of the heat exchange structure, which may both be open and closed,

regardless of the size of this heat exchange structure.

Another object of the invention is to provide a method for manufacturing such a heat exchange structure which is not limited by the material of the substrate of this structure, by the shape or by the size of the latter and which, more generally, is easy to apply. In particular, this method does not impose that a geometrical heterogeneity of said heat exchange surface be achieved, notably by mechanical structuration or by laser etching in order to form nucleation sites.

### DISCUSSION OF THE INVENTION

The objects listed earlier as well as others are attained, firstly, by a heterogeneous heat exchange structure of the aforementioned type, i.e. which applies heat transfer by boiling a liquid and which comprises a substrate and a heat exchange surface intended to be in contact with said liquid.

According to the invention, this heat exchange surface comprises at least one molecular switch having a lower critical solubility temperature T_{LCST} above which it imparts to the heat exchange surface non-wetting properties towards the liquid and below which it imparts to the heat exchange surface wetting properties towards the liquid, this lower critical solubility temperature T_{LCST} of the molecular switch being selected so as to be greater than or equal to the saturation temperature Tₛₐₜ of the liquid.

A molecular switch is a compound which reversibly oscillates between two or several states under the effect of a stimulus.

Within the scope of the present invention, this molecular switch has wetting properties towards a liquid which varies according to the temperature. More specifically, this molecular switch has a temperature that is called <<lower critical solubility temperature>> and noted as <<T_{LCST}>> in the continuation of the present description, above which it is characterized by non-wetting properties towards the relevant liquid while below this temperature, it is characterized by wetting properties towards this same liquid.

The wetting properties of a liquid on a solid surface are determined by the shape which a drop of this liquid assumes at this surface, under the effect of the molecular interactions between the three phases in presence (solid/liquid/gas of the environment) and, more particularly, by the value of the contact angle θ at the interface between the drop and the solid surface. By definition, when θ<90°, the drop of the liquid wets the surface. This is then stated that the surface has <<wetting>> properties towards this liquid. Conversely, when θ≧90°, the drop of the liquid does not wet the surface. This surface then has so-called <<non-wetting>> properties towards this liquid.

An illustration of the heat-dependent variation of the wetting properties given by a molecular switch in the sense of the invention is given by FIG. 1. More specifically, the curve illustrated in FIG. 1 illustrates the variation of the value of the contact angle θ formed by a drop of water on a heat exchange surface comprising a polyethylene glycol (PEG) as a molecular switch, depending on the temperature of this heat exchange surface.

As this may be observed in FIG. 1, the value of the contact angle θ is constant and equal to 80° for heat exchange surface temperatures ranging up to 100° C. In this first interval of temperatures, the molecular switch therefore gives wetting properties (or hydrophilic properties since in this case, the liquid is water) to the heat exchange surface. From 100° C. and up to a temperature of about 107° C., which corresponds to a second interval of temperatures, the contact angle θ strongly increases until it stabilizes at a value of contact angle θ equal to 105°, a value which is retained in a third interval of temperatures, which corresponds to temperatures above 107° C. In this third interval of temperatures, the molecular switch gives non-wetting (or hydrophobic in the present case) properties to the heat exchange surface.

In the case illustrated in FIG. 1, the reversible transition between the wetting and non-wetting properties occurs on the second interval of temperatures, this second interval, comprised between 100° C. and 107° C., corresponding to the lower critical solubility temperature T_{LCST} of the molecular switch. In the present case, the fact that this lower critical solubility temperature T_{LCST} is defined by an interval of temperatures results from dispersion of the wetting properties which the molecular switch may give to the heat exchange surface, when this molecular switch is not regularly distributed on the substrate. Thus, more the distribution of the molecular switch on the substrate is regular and homogenous, the more narrow is the interval in which is included the lower critical solubility temperature T_{LCST} of this molecular switch, or even it is established at a temperature value.

Thus, by varying the distribution of the molecular switch on the substrate, it is possible to modify the value of the lower critical solubility temperature T_{LCST} of this molecular switch and therefore the wetting priorities of the corresponding heat exchange structure.

The selection of a molecular switch as defined above gives the possibility of having a heat exchange structure which benefits from wetting characteristics which depend on temperature.

Indeed, when the heat exchange structure is heated, by heating means, in the presence of the liquid at a temperature above the saturation temperature of this liquid in order to allow boiling of the latter, the temperature of this structure, and therefore of its heat exchange surface, will increase until it reaches and then exceeds the lower critical solubility temperature T_{LCST} of the molecular switch present at the heat exchange surface. At this temperature above T_{LCST}, the molecular switch, which is selected so as to give non-wetting properties towards the liquid, promotes the formation of bubbles and the starting of boiling. During the growth phase of the bubbles, a sudden and very fast decrease of the temperature of the areas of the heat exchange surface located under the bubbles occurs. This decrease may typically be of the order of 10° C. with a liquid like water and be accomplished within a period of a few milliseconds. This decrease of the temperature of said areas causes a general decrease of the temperature of the heat exchange surface down to a temperature below T_{LCST} and at which the molecular switch gives wetting properties to the heat exchange surface. Heat transfer from the heat exchange surface to the bubbles is thus improved, just like the detachment of these bubbles from this surface, thereby ensuring a high frequency of emission of bubbles. After detachment of the bubbles, the areas of the heat exchange surface located beforehand under these bubbles are re-wetted by liquid. These areas are therefore no more cooled down efficiently and have their temperature rise above T_{LCST}. At this temperature, the heat exchange surface has non-wetting properties which promote the formation of bubbles. A new cycle for forming, growing and detaching bubbles will thus be established.

The selection of a heat exchange surface comprising a molecular switch as defined above, which promotes both formation, growth and detachment of the bubbles, therefore gives the possibility of producing a heterogeneous heat exchange structure allowing improved heat transfer by boiling.

In a particular version of the invention, the lower critical solubility temperature T_{LCST} of the molecular switch of the layer intended to be in contact with the liquid is comprised between Tₛₐₜ and Tₛₐₜ+20° C.

The selection of a T_{LCST} which does not exceed the value of Tₛₐₜ+20° C. gives the possibility of contemplating a use of the heat exchange structure according to the invention, without any excessive overheating of the heat exchange structure. This has a certain advantage in terms of limitation of the energy consumption and of the lifetime of the heat exchange structure.

It is specified that the expression <<comprised between . . . and . . . >> which has just been mentioned and which is used in the present application should be understood as defining not only the values of the interval, but also the values of the limits of this interval.

According to a particular embodiment of the invention, the lower critical solubility temperature T_{LCST} of the molecular switch is advantageously comprised between Tₛₐₜ and Tₛₐₜ+10° C. and, preferentially between Tₛₐₜ and Tₛₐₜ+5° C.

Thus, the selection of an interval narrowed around the value of T_{LCST} of the molecular switch gives the possibility of favoring the frequency for forming bubbles, on the one hand, and the frequency of their growth and of their detachment, on the other hand. In other words, the selection of such a narrowed interval gives the possibility of optimizing the heat transfer ensured by the heat exchange structure according to the invention.

Within the scope of the present invention, the heat exchange surface intended to be in contact with the liquid may only comprise a single molecular switch. The selection of such a heat-dependent compound is advantageously made according to the range of temperatures which is targeted and which is determined by the saturation temperature of the liquid. This saturation temperature corresponds to the boiling temperature if the heat exchange by boiling occurs at atmospheric temperature. The application of a single molecular switch for producing a heterogeneous heat exchange structure represents a real advantage as compared with the complex heterogeneous structures of the prior art, in particular those described in documents EP 2 028 432 A1 and WO 2010/012798 A1.

But nothing prevents contemplation of the application of a heat exchange surface comprising two or several different molecular switches in order to cover two or several intervals of temperatures. Further, and as this was explained herein before, it is also possible to vary the distribution of these two or several switches on the substrate and thus modify the priorities of wetting of the corresponding heat exchange structure.

In order to optimize its adherence in the heat exchange structure, the molecular switch is advantageously selected so as to be able to be grafted to the substrate. Another advantage related to grafting lies in the fact that it is possible to contemplate this regardless of the constitutive material of this substrate. Thus, the substrate of the heat exchange structure according to the invention may be in metal, in polymer(s) or further in a composite or ceramic material, notably based on oxides, carbides or further nitrides. The heat exchange structure is therefore not limited by the material of the substrate, unlike the structure described in document WO 2010/012798 A1.

Several grafting modes may be contemplated.

According to a first grafting mode, the molecular switch comprises at least one functional group which may react with a coupling agent in order to form a modified molecular switch, this modified molecular switch itself being able to react with the substrate.

This functional group is advantageously selected from the group formed by an alcohol, a carboxylic acid and an amine.

In particular, in the case when the functional group present on the molecular switch is an alcohol, a coupling agent which may form a urethane bond is preferred. Thus, the coupling agent is advantageously a silane comprising an isocyanate group, preferably selected from the group formed by OCN(CH₂)₃Si(OEt)₃, OCN(CH₂)₃Si(OMe)₃ and OCN(CH₂)₃SiMe₂Cl.

In the case when the functional group present on the molecular switch is a carboxylic acid, a coupling agent which may form an amide bond is preferred.

Finally, in the case when this functional group present on the molecular switch is an amine, a coupling agent which may form a urea bond is preferred.

In order to illustrate this first grafting mode, the preparation of a modified molecular switch is described hereafter, and then the grafting of the latter on a substrate, notably when this substrate is in metal or based on oxide(s).

More generally, the substrate is produced in a material having good heat conduction properties. This substrate may, as already indicated above, be in metal, but also in ceramic (notably in graphic covalent ceramic) or further in a composite material, based on oxide(s) and/or comprising carbon nanotubes.

The molecular switch considered here is a polyethylene glycol. This polyethylene glycol is modified by adding, in anhydrous dichloromethane, the silane coupling agent bearing an isocyanate group OCN(CH₂)₃Si(OEt)₃. The reaction which occurs is the following, it being specified that the urethane covalent bond is formed instantaneously:

H(OCH₂CH₂)ₙOH+OCN(CH₂)₃Si(OEt)₃→H(OCH₂CH₂)ₙOCONH(CH₂)₃Si(OEt)₃

The reaction product is a modified polyethylene glycol including a silane functional group which may react with the substrate.

The substrate is then soaked in an anhydrous solution comprising the modified polyethylene glycol H(OCH₂CH₂)ₙOCONH(CH₂)₃Si(OEt)₃ and dichloromethane, and then exposed to the atmosphere. Hydrolysis of the modified polyethylene glycol including a silane functional group occurs in the presence of atmospheric water. This hydrolysis is conducted, in a first phase, at room temperature and then, in a second phase, in an oven at 100° C. for 5 minutes. FIG. 2a illustrates the corresponding hydrolysis reaction. At the end of the reaction, the modified molecular switch is grafted to the substrate through the bond H(OCH₂CH₂)ₙOCONH(CH₂)₃Si(O—)₃, in order to form a nanometric organosilane oxide layer fitting the generic formula R—Si(O—)₃.

As indicated above, other silane coupling agents bearing an isocyanate function may be used. As examples, mention may be made of OCN(CH₂)₃Si(OMe)₃ and OCN(CH₂)₃SiMe₂Cl.

Thus, the use of OCN(CH₂)₃SiMe₂Cl instead of OCN(CH₂)₃Si(OEt)₃ in the procedure which has just been described, allows grafting of another modified molecular switch to the substrate, as illustrated in FIG. 2b.

According to a second grafting mode, the molecular switch comprises at least one functional group which may react with at least one functional group of the substrate.

In order to introduce this functional group on the substrate, the substrate is therefore modified. This functional group of the substrate is advantageously an amine, and preferably, a primary amine.

In order to functionalize this substrate with an amine, a first method consists of having the substrate, in particular when the latter is in metal or based on an oxide, react with an alanine derivative, such as an alanine catechol. The hydroxy groups of the catechol will react with the substrate in order to form a catecholate, the NH₂ of the amino acid group of alanine remaining free for reacting with the functional group of the molecular switch. A nanometric organic layer is therefore formed between the substrate and the molecular switch.

A second method giving the possibility of introducing this amine functional group on the substrate consists of having the substrate react with a silane coupling agent comprising an amine function, and then carrying out hydrolysis in order to obtain, as described above for the first grafting mode of the molecular switch on the substrate, a nanometric oxide layer of the R—Si(O—)_{z} type, with z=1 to 3.

From among the silane coupling agents which may be suitable, mention may advantageously be made of those fitting the formula NH₂ (CH₂)ₙSiR₁ₓ(Y)₃₋ₓ, wherein:

n=3 to 6,

R₁═CH₃ or C₂H₅,

x=0 to 2, and

Y═Cl or OR₂, with R₂═CH₃ or C₂H₅.

A third method allowing functionalization of the substrate by an amine consists of applying the so-called <<diazonium-induced anchorage process>> or DIAP. This DIAP method gives the possibility of grafting covalently, at room temperature, at atmospheric pressure, in an aqueous medium and without any external provision of energy, an aryldiazonium salt on the substrate and this, regardless of the material of the substrate. The latter may therefore be in metal, in polymer(s) or in a composite or ceramic material. The aryldiazonium salt grafted on the substrate leaves a free amine function formed by the aniline radical —C₆H₅—NH₂.

Advantageously, and notably when the functional group of the substrate is formed by an amine, preferably a primary amine, the functional group of the molecular switch is a succinimidyl ester. This succinimidyl ester may notably be formed by either one of the succinimidyl esters appearing in the first column of Table 1 hereafter.

In the second column of this Table 1, appears the semi-structural formula of the molecular switch comprising the succinimidyl ester functional group corresponding to each of the esters of the first column, the relevant molecular switch being polyethylene glycol, abbreviated as PEG, and the succinimidyl function moreover being abbreviated as NHS.

The hydrolysis of the molecular switch comprising a succinimidyl ester group in the presence of the substrate comprising an amine group gives the possibility of obtaining the grafting of the molecular switch on the substrate, according to the reaction illustrated in FIG. 3.

This hydrolysis reaction is perfectly under control, as indicated by the half-life times (measured during a hydrolysis conducted at a pH of 8 and at 25° C.) reported in the third column of Table 1.

TABLE 1

| Succinimidyl | | Half-life |
|---|---|---|
| ester (acronym) | PEG, after reaction with said ester | (mins) |
| Succinimidyl valerate (SVA) | PEG-O—CH₂CH₂CH₂CH₂—CO₂—NHS | 33.6 |
| Succinimidyl carbonate (SC) | PEG-O—CO₂—NHS | 20.4 |
| Succinimidyl glutarate (SG) | PEG-O₂C—CH₂CH₂CH₂—CO₂—NHS | 17.6 |
| Succinimidyl succinate (SS) | PEG-O₂C—CH₂CH₂—CO₂—NHS | 9.8 |
| Succinimidyl carboxymethyl (SCM) | PEG-O—CH₂—CO₂—NHS | 0.75 |
| Succinimidyl propionate (SPA) | PEG-O—CH₂CH₂—CO₂—NHS | 16.5 |

As this clearly emerges from Table 2 below, it is possible to modify the reactivity of this hydrolysis reaction and therefore the reactivity of the grafting of the molecular switch comprising the succinimidyl ester functional group on the substrate comprising the NH₂ functional group, by intervening on the hydrolysis conditions.

TABLE 2

| Succinimidyl | | | Temperature | Half-life |
|---|---|---|---|---|
| Ester (acronym) | PEG, after reaction with said ester | pH | (° C.) | (mins or s) |
| Succinimidyl | PEG-O—CH₂CH₂CH₂CH₂—CO₂—NHS | 8.0 | 25 | 33.6 min |
| valerate (SVA) | | 8.5 | 25 | 9.8 min |
| | | 9.0 | 25 | 3.1 min |
| | | 10.0 | 25 | 56 s |

According to an embodiment of the invention, the molecular switch is only grafted on a portion of the substrate of the heat exchange structure according to the invention. Preferably, the molecular switch is grafted on the whole surface of the substrate intended to be in contact with the liquid, in order to form with this surface, the heat exchange surface.

The molecular switch may in particular be a homopolymer or a copolymer.

In the case when the molecular switch is a homopolymer, it may notably be selected from the group formed by a poly(N-isopropylacrylamide) or polyNIPAM as an acronym, a polyvinylcaprolactam, a hydroxypropylcellulose, a polyoxazoline, a polyvinylmethylether and a polyethylene glycol (PEG).

Listed in Table 3 below, are the values of the low critical solubility temperature T_{LCST} of the homopolymers which have just been listed.

TABLE 3

| Homopolymer | T_{LCST} (in ° C.) |
|---|---|
| poly(N-isopropylacrylamide) ou polyNIPAM | 32 |
| Polyvinylcaprolactame | 37 |
| Hydroxypropylcellulose | between 40 and 56 |
| Polyoxazoline | 70 |
| Polyvinylmethylether | 45 |
| polyethylene glycol (PEG) | between 100 and 130 |

It is observed that for certain homopolymers, the values of T_{LCST} may be located in an interval. As examples, the values of T_{LCST} of hydroxypropylcellulose and of polyethylene glycol are respectively comprised between 40° C. and 56° C. and between 100° C. and 130° C. and in particular depend on the molecular mass of the relevant polymer.

In an alternative of the invention, it is quite possible to apply a molecular switch obtained by copolymerization of two or more co-monomers. Under this assumption, the molecular switch is a copolymer. In particular, such a copolymer may be contemplated when it is desired to modify the lower critical solubility temperature T_{LCST} given by a homopolymer.

It is also possible to modify this value of T_{LCST} by selecting a homopolymer or a copolymer comprising a charge, in which case a decrease in this value is observed. Conversely, the introduction of an amphiphilic group in a homopolymer or in a copolymer gives the possibility of increasing this value of T_{LCST}.

More generally, the molecular switch may be mixed with a salt, a surfactant or a solvent. Such additional compounds also allow substantial modification of the lower critical solubility temperature T_{LCST} of a given molecular switch, while retaining the reversible transition profile between the wetting and non-wetting properties. The addition of a salt allows a decrease in this value while that of a surfactant or of a solvent allows its increase.

Among the salts which may thus be added, mention may notably be made of salts of alkaline metals like lithium, sodium or potassium. For example, mention may be made of halides and acetates of such alkaline metals.

Among the surfactants which may also be added, mention may be made of polysorbates (also called Tween), ammonium or phosphonium salts comprising alkyl or aryl groups and halide ions, and certain non-ionic surfactants such as poly(n-alkyl)phenoxypolyethoxyethanols, n-alkyl being a nonyl or an octyl, like those marketed by Rhodia under the trade name of Igepal®.

From among the solvents which may also be added, mention may be made of alcohols such as ethanol, propanol, butanol or further ethylene glycol.

In an advantageous version of the invention, the heat exchange surface which comprises said at least one molecular switch, has a thickness of less than or equal to 1 μm, advantageously comprised between 1 nm and 500 nm and, preferentially, between 5 nm and 100 nm.

Such a thickness generates heat resistance which is negligible in comparison with the heat exchange during boiling and which is therefore not detrimental to the heat transfer ensured by the heat exchange structure according to the invention.

The object of the present invention is also an assembly applying a heat transfer by the boiling of a liquid, this assembly comprising a heat exchange structure according to the invention, the heat exchange structure being as defined above, as well as heating means allowing boiling of the liquid at the heat exchange surface.

The heating means may notably be ensured with an electric power supply. These heating means may, if necessary, be completed with means for regulating the temperature, for example with a thermostat.

The aforementioned goals are also attained, secondly, by a method for manufacturing a heat exchange structure applying heat transfer by boiling of a liquid, said heat exchange structure comprising a substrate and a heat exchange surface intended to be in contact with said liquid, this heat exchange structure being as defined above.

According to the invention, this method comprises a deposition step, on all or part of the substrate, of at least one molecular switch having a lower critical solubility temperature T_{LCST} above which it gives to the heat exchange surface non-wetting properties towards the liquid and below which it gives to the heat exchange surface wetting properties towards the liquid, this lower critical solubility temperature T_{LCST} of the molecular switch being selected so as to be greater than or equal to the saturation temperature Tₛₐₜ of the liquid.

According to an advantageous embodiment of the invention, the lower critical solubility temperature T_{LCST} of the molecular switch is comprised between Tₛₐₜ and Tₛₐₜ+20° C., advantageously between Tₛₐₜ and Tₛₐₜ+10° C. and, preferentially, between Tₛₐₜ and Tₛₐₜ+5° C.

By means of the method according to the invention, a heat exchange structure provided with a heterogeneous heat exchange surface by depositing, on all or part of the substrate, at least one particular molecular switch which gives wetting and non-wetting properties to the heat exchange surface intended to be in contact with the liquid, is produced concomitantly, this heat exchange surface being formed by the substrate coated with this at least one molecular switch.

Further it is not necessary to proceed with a preliminary treatment of the substrate in order to give it a particular geometry aiming at generating nucleation sites, for example by mechanical structuration or by laser etching.

If this substrate may be smooth, it may also be subject to an additional microscopic or macroscopic treatment step, before depositing the layer intended to be in contact with the liquid. This additional step, which may notably be expressed by the formation of micro-fins, protrusions or cavities (notably by a porous layer deposit), gives the possibility of improving the heat transfer performances by boiling. The advantages of the additional step are thus added to those given by the method of the invention.

The method according to the invention is relatively easy to apply. Further, it is not limited, regardless of the size of the substrate or of its shape, unlike the method described in document WO 2010/012798 A1. In particular, the method according to the invention may be applied for making an open heat exchange structure but also a closed heat exchange structure, such as a tube.

Such a deposition of at least one molecular switch may further be contemplated, regardless of the material of the substrate, the substrate being able to be equally in metal, in polymer(s) or further in a composite or ceramic material.

By means of the method of the invention, it is also possible to contemplate producing the deposit of this molecular switch, on a substrate of an old heat exchange structure, in order to improve the performances thereof.

Within the scope of the method for manufacturing the heat exchange structure according to the invention, the deposition step is preferably achieved by grafting.

According to a first embodiment of the method according to the invention, the deposition step is carried out by grafting, on the substrate, a modified molecular switch. This modified switch is obtained by the reaction of a coupling agent with the molecular switch which comprises a functional group which may react with this coupling agent.

As this has already been described above, this functional group of the molecular switch is advantageously selected from the group formed by an alcohol, a carboxylic acid and an amine.

In particular, in the case when the functional group present on the molecular switch is an alcohol, a coupling agent which may form a urethane bond is preferred. Thus, the coupling agent is advantageously a silane comprising an isocyanate group, preferably selected from the group formed with OCN(CH₂)₃Si(OEt)₃, OCN(CH₂)₃Si(OMe)₃ and OCN(CH₂)₃SiMe₂Cl.

Reference will be made to what was described above and what was illustrated by FIGS. 2a and 2b for the applied reactions for this deposition by grafting.

However, it is specified that, if the method according to the invention prefers the preliminary reaction of the coupling agent with the molecular switch, before grafting the modified molecular switch on the substrate, it may also be contemplated to have the molecular switch react with the coupling agent, this coupling agent being grafted beforehand on the substrate. However, this alternative of the method would lead to low yields, in particular in the case when the coupling agent comprises an isocyanate group which, being particularly reactive in the presence of water, would react with traces of water before reacting with the functional group of the molecular switch introduced in a second step.

According to a second embodiment of the method according to the invention, the deposition step is carried out by grafting, on the substrate comprising a functional group, the molecular switch also comprising a functional group which may react with this functional group of the substrate.

According to this second embodiment, the substrate is therefore modified and comprises a functional group which is advantageously an amine and preferably a primary amine.

Reference will be made to what was described earlier in connection with the methods, three in number, which give the possibility of introducing the amine functional group onto the substrate.

Advantageously, and notably when the functional group of the substrate is formed with an amine, preferably a primary amine, the functional group of the molecular switch is a succinimidyl ester. This succinimidyl ester may notably be formed with eitherone of the succinimidyl esters appearing in the first column of Table 1 above.

The method for manufacturing the heat exchange structure according to the invention, notably when the deposition step is carried out by grafting, may be applied via a wet route, for example by quenching or by circulation, in optionally closed treatment tanks, comprising the reactive solutions.

The present invention also relates to a method for manufacturing an assembly applying a heat transfer by boiling a liquid, this assembly being as defined above and comprising a heat exchange structure according to the invention as well as heating means allowing boiling of the liquid at the heat exchange surface.

According to the invention, this method for manufacturing the assembly comprises a step for connection of a heat exchange structure manufactured by the manufacturing method as defined above, to heating means.

The object of the present invention is further a heat exchange device applying a heat transfer by boiling a liquid, this heat exchange device comprising said liquid and a heat exchange structure according to the invention, as defined above.

The liquid is conventionally a heat transfer liquid and may notably be water or an aqueous solution. Other non-wetting liquids may also be contemplated.

Finally, the object of the present invention is the use of a heat exchange structure according to the invention, of an assembly according to the invention or of a heat exchange device according to the invention in a boiler, a diphasic thermosiphon or a heat pipe.

Other features and advantages of the invention will become apparent upon reading the additional description which follows, which relates to an example for preparing a modified molecular switch, to the manufacturing of a heat exchange structure according to the invention as well as to experimental results illustrating the excellent heat transfer properties of this structure.

Of course, these examples are only given as an illustration of the object of the invention and by no means are a limitation of this object.

### SHORT DESCRIPTION OF THE DRAWINGS

The present invention will be illustrated by the detailed discussion of particular embodiments which follows and of the following appended figures:

FIG. 1 illustrates the variations in the wetting properties according to the temperature of a molecular switch which may be applied in the heat exchange structure according to the invention;

FIGS. 2a and 2b correspond to the reaction for hydrolysis and binding, on the substrate, the polyethylene glycol grafted by two distinct silane coupling agents bearing an isocyanate group;

FIG. 3 corresponds to the reaction for hydrolysis and binding, on the substrate comprising an —NH₂ group, polyethylene comprising a succinimidyl valerate group;

FIG. 4 is a schematic illustration of the experimental device used during the tests;

FIG. 5 shows the evolution of the heat flow dissipated by two heat exchange structures, one of which is according to the invention, versus the overheating required for boiling; and

FIG. 6 shows the evolution of the heat exchange coefficient versus the heat flow dissipated by these same two heat exchange structures.

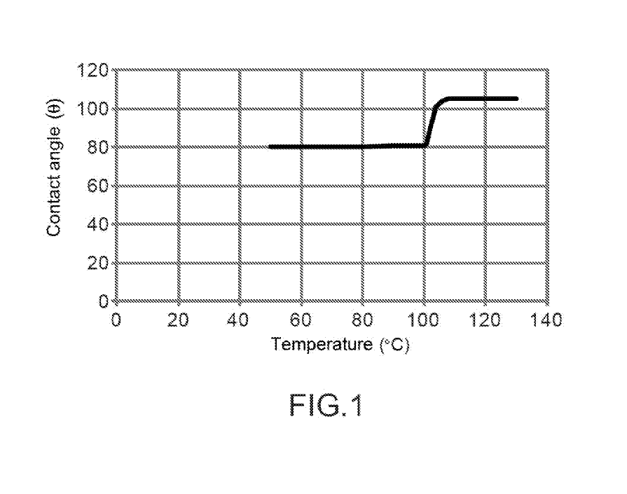

FIGS. 1, 2a, 2b and 3 have each been the subject of a comment in the preceding chapter.

### DETAILED DISCUSSION OF PARTICULAR EMBODIMENTS

During tests, two heat exchange structures were tested. Both of these structures comprise a same substrate, formed with a sheet, also called a foil, in stainless steel with a length of 10 cm, a width of 5 mm and a thickness of 20 μm.

In order to manufacture the heat exchange structure according to the invention, the retained molecular switch was a polyethylene glycol (PEG) with a number average molecular mass Mn of 35,000 g/mol and with a lower critical solubility temperature comprised between 108° C. and 114° C. This PEG was modified by adding, in anhydrous dichloromethane, the silane coupling agent comprising an isocyanate group OCN(CH₂)₃Si(OEt)₃. The stainless steel substrate was then soaked in an anhydrous solution comprising dichloromethane and the thereby modified PEG, and then was exposed to the atmosphere. Hydrolysis took place in the presence of atmospheric water. This hydrolysis was conducted, firstly, at room temperature and then, secondly, in an oven at 100° C. for 5 minutes. The modified and then grafted PEG on the stainless steel substrate has a lower critical solubility temperature T_{LCST} of 108° C.

In order to manufacture the reference heat exchange structure, the stainless steel substrate was soaked in an anhydrous solution comprising dichloromethane and the same coupling agent OCN(CH₂)₃Si(OEt)₃, and then was exposed to the atmosphere. Hydrolysis took place in the presence of atmospheric water. This hydrolysis was conducted, firstly, at room temperature and then, secondly, in an oven at 100° C. for 5 minutes. Indeed it is known that in the case of sterically hindered coupling agents, it is advantageous to complete the hydrolysis with a heat treatment in order to optimize the mechanical strength to the grafting substrate made.

It is specified that the reference heat exchange structure and the heat exchange structure according to the invention both have, before the boiling tests, wetting properties equivalent to a value of contact angle θ of 80° at room temperature.

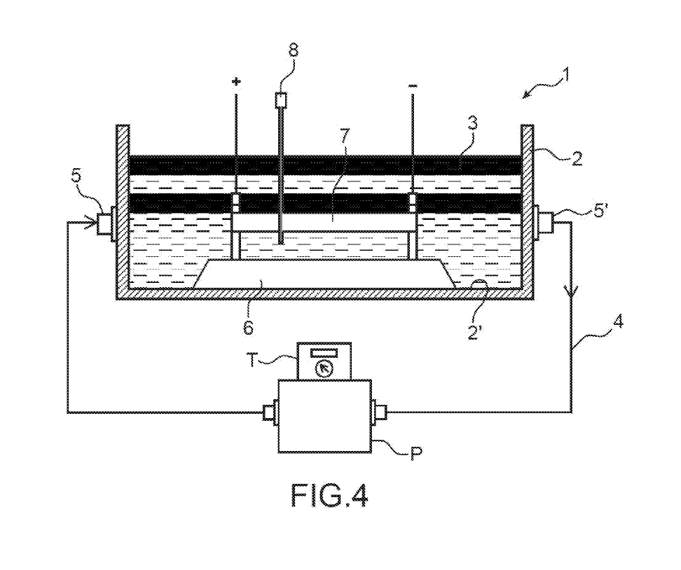

The experimental device illustrated by FIG. 4 was used for conducting the tests.

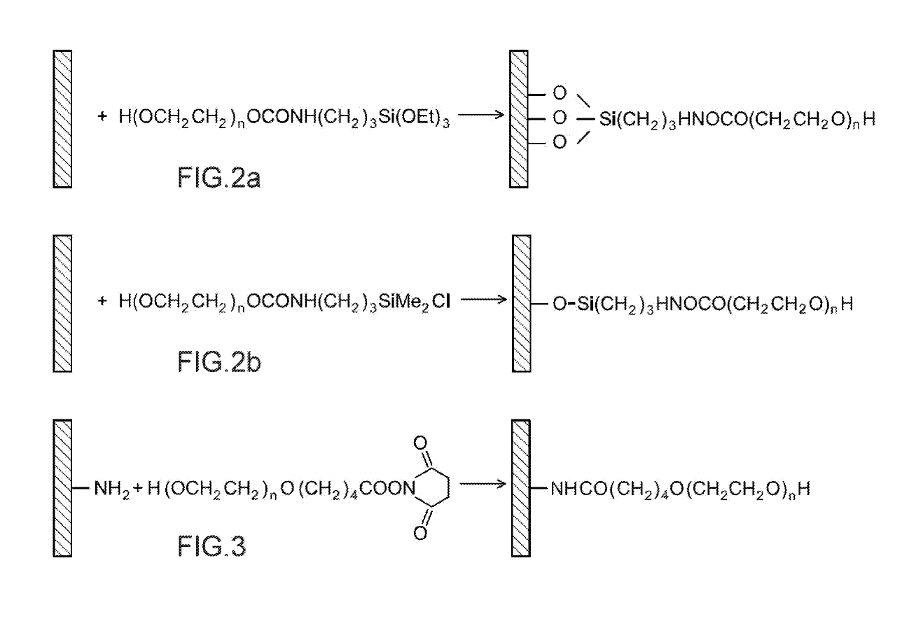

This device 1 comprises a thermostatic pan 2 containing a liquid 3. A circuit 4 for circulating the liquid 3 equipped with a pump P is connected between an inlet 5 and an outlet 5′ of the pan 2. The pump P is associated with a thermostat T giving the possibility of controlling the temperature of the liquid 3 contained in the pan 2. On a support 6 attached on the bottom 2′ of the pan 2, a heat exchange structure 7 is positioned horizontally. This structure 7 is connected to an electric power supply schematized in FIG. 2, by positive (+) and negative (−) terminals, as well as to a thermocouple 8, which may be a thermocouple of K type. The Joule effect induced by the current generated by the electric power supply gives the possibility of causing the boiling of the liquid 3 in proximity to the heated heat exchange structure 7.

The whole of the test was carried out with the heat exchange structure 7 immersed in the liquid bath 3 formed by deionized and degassed water, maintained at a constant temperature of 85° C. by means of the thermostat T. The measurements taken by the thermocouple 8 allowed quantification of the heat exchanges by boiling.

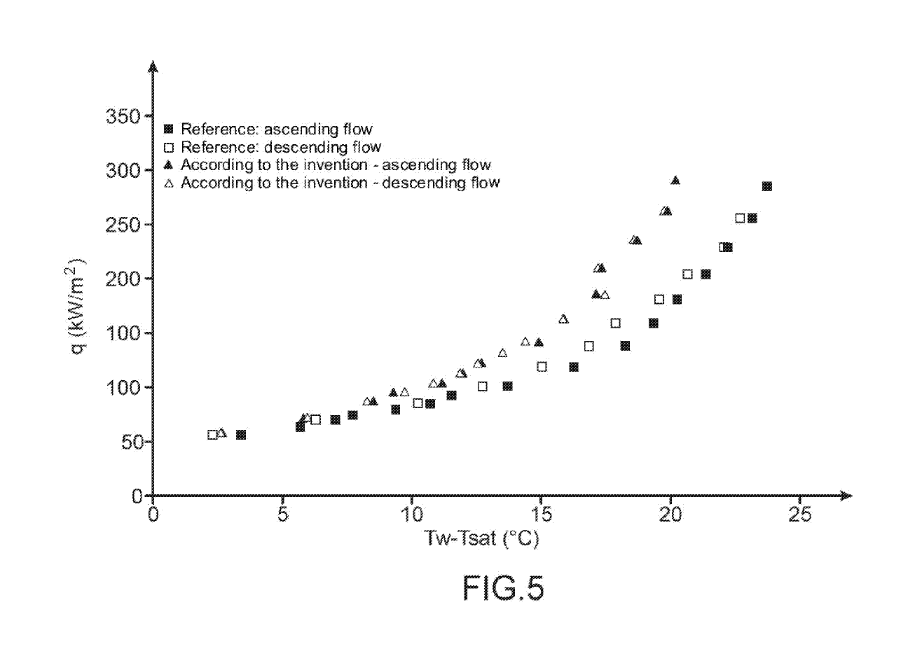

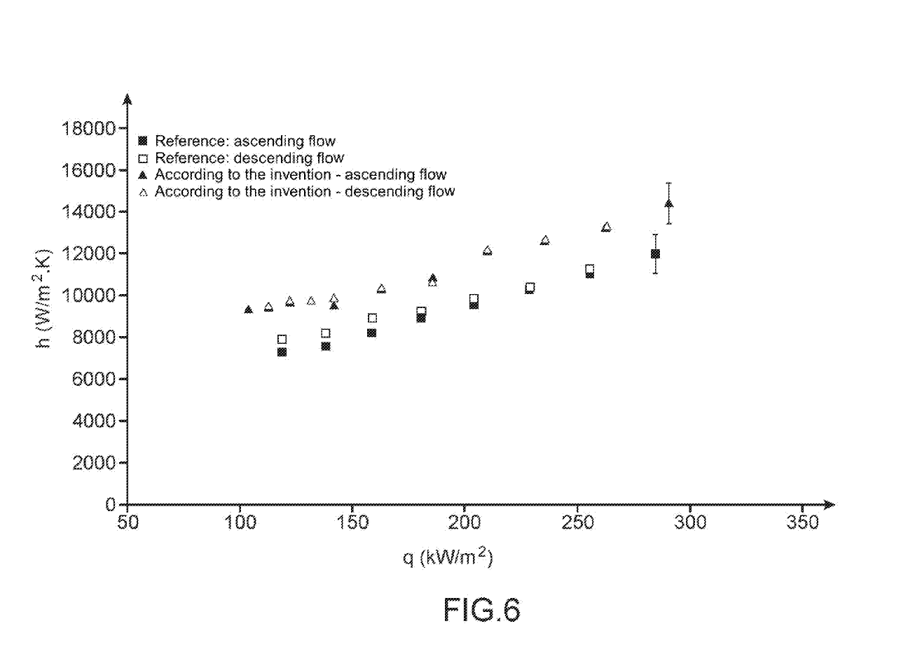

It is specified that these tests were conducted, firstly, for increasing heat flows and then, secondly, for decreasing heat flows. In the first case, the heat flow values taken (noted as <<ascending flow>>) are illustrated by a solid symbol (triangle or square) in FIGS. 5 and 6; in the second case, these values (noted as <<descending flow>>) are illustrated by an empty symbol (triangle or square) in these same FIGS. 5 and 6.

FIG. 5 shows the evolution of the heat flow noted as q (in kW/m²) dissipated by the heat exchange structure depending on the overheating noted as T_{w}−Tₛₐₜ (in ° C.) required for boiling the deionized and degassed water, T_{w} representing the temperature of the tested heat exchange structure and Tₛₐₜ the saturation temperature of this water at atmospheric pressure (boiling temperature).

In this FIG. 5, it is observed that from an overheating value T_{w}−Tₛₐₜ of the order of 8° C., which corresponds to a heat exchange structure temperature of 108° C. (Tₛₐₜ being of the order of 100° C. at atmospheric pressure), the flow dissipated by the heat exchange structure according to the invention is greater than the flow dissipated by the reference heat exchange structure. In particular, for overheating values T_{w}−Tₛₐₜ comprised between 8° C. and 18° C., which correspond to a heat exchange structure temperature comprised between 108° C. and 118° C., an increase in the slope of the dissipated flow curve obtained with the heat exchange structure according to the invention is even observed, as compared with that of the dissipated flow curve obtained with the reference heat exchange structure. Beyond an overheating value of 18° C., the heat transfers remain better with the heat exchange structure according to the invention.

FIG. 6 shows the evolution of the heat exchange coefficient noted as h (in W/m²·K) versus the heat flow q (in kW/m²) dissipated by the inventive and reference heat exchange structures.

This FIG. 6 actually confirms the improved performances obtained with the heat exchange structure according to the invention. A strong increase in the heat exchange coefficient h is even observed from a dissipated flow value q of the order of 185 kW/m², corresponding to a value of T_{w} of about 118° C.

Moreover it is observed that the curves obtained for the two series of tests, i.e. for increasing and decreasing heat flows, are practically superposable. This observation therefore expresses satisfactory reproducibility of the results as well as good strength of the grafting carried out for each of the heat exchange structures, in particular of the grafting giving the possibility of obtaining the heat exchange structure according to the invention.

1. A heat exchange structure applying a heat transfer by boiling a liquid, said heat exchange structure comprising:
a substrate and a heat exchange surface intended to be in contact with said liquid, said heat exchange surface comprising at least one molecular switch having a lower critical solubility temperature T_{LCST} above which it gives the heat exchange surface non-wetting properties towards the liquid and below which it gives to the heat exchange surface wetting properties towards the liquid, this lower critical solubility temperature T_{LCST} of the molecular switch being selected so as to be greater than or equal to the saturation temperature Tₛₐₜ of the liquid.

2. The heat exchange structure according to claim 1, wherein the lower critical solubility temperature T_{LCST} of the molecular switch is comprised between Tₛₐₜ and Tₛₐₜ+20° C., advantageously between Tₛₐₜ and Tₛₐₜ+10° C. and preferentially, between Tₛₐₜ and Tₛₐₜ+5° C.

3. The heat exchange structure according to claim 1, wherein the molecular switch comprises at least one functional group which may react with a coupling agent in order to form a modified molecular switch which may react with the substrate, the functional group being advantageously selected from the group formed with an alcohol, a carboxylic acid and an amine,

4. The heat exchange structure according to claim 3, wherein the coupling agent is a silane comprising an isocyanate group, the coupling agent being preferably selected from the group formed with OCN(CH₂)₃Si(OEt)₃, OCN(CH₂)₃Si(OMe)₃ and OCN(CH₂)₃SiMeₛCl.

5. The heat exchange structure according to claim 1, wherein the molecular switch comprises at least one functional group which may react with at least one functional group of the substrate, this functional group of the substrate advantageously being an amine, preferably a primary amine.

6. The heat exchange structure according to claim 5, wherein the functional group of the molecular switch is a succinimidyl ester.

7. The heat exchange structure according to claim 1, wherein the molecular switch is a homopolymer, preferably selected from the group formed with a poly(N-isopropylacrylamide), a polyvinylcaprolactam, a hydroxypropylcellulose, a polyoxazoline, a polyvinylmethylether and a polyethylene glycol.

8. The heat exchange structure according to claim 1, wherein the molecular switch is a copolymer, said copolymer may comprise a charge or an amphiphilic group.

9. The heat exchange structure according to claim 1, wherein the heat exchange surface which comprises said at least one molecular switch has a thickness of less than or equal to 1 μm, advantageously comprised between 1 and 500 nm and, preferentially between 5 and 100 nm.

10. An assembly applying a heat transfer by boiling of a liquid, said assembly comprising:
a heat exchange structure according to claim 1; and
heating means allowing boiling of said liquid at the heat exchange surface.

11. A heat exchange device applying a heat transfer by boiling of a liquid, said heat exchange device comprising said liquid and a heat exchange structure according to claim 1.

12. The heat exchange structure according to claim 1, wherein said heat exchange structure is included in a boiler, a diphasic thermosiphon or a heat pipe.

13. A method for manufacturing a heat exchange structure according to claim 1, comprising:
a step for depositing, on all or part of a substrate, at least one molecular switch having a lower critical solubility temperature T_{LCST} above which it gives the layer non-wetting properties towards the liquid and below which it gives to the layer wetting properties towards the liquid, this lower critical solubility temperature T_{LCST} of the molecular switch being selected so as to be greater than or equal to the saturation temperature Tₛₐₜ of the liquid.

14. The manufacturing method according to claim 13, wherein the lower critical solubility temperature T_{LCST} of the molecular switch is comprised between Tₛₐₜ and Tₛₐₜ+20° C., advantageously between Tₛₐₜ and Tₛₐₜ+10° C. and preferentially, between Tₛₐₜ and Tₛₐₜ+5° C.

15. The manufacturing method according to claim 13, wherein the deposition step is achieved by grafting on the substrate, a modified molecular switch obtained by reaction of a coupling agent and of the molecular switch comprising a functional group which may react with this coupling agent, this functional group being advantageously selected from the group formed by an alcohol, a carboxylic acid and an amine.

16. The manufacturing method according to claim 15, wherein the coupling agent is a silane comprising an isocyanate group, preferably selected from the group formed by OCN(CH₂)₃Si(OEt)₃, OCN(CH₂)₃Si(OMe)₃ and OCN(CH₂)₃SiMe₂Cl.

17. The manufacturing method according to claim 13, wherein the deposition step is achieved by grafting, on the substrate comprising a functional group, the molecular switch comprising a functional group which may react with this functional group of the substrate, this functional group of the substrate advantageously being an amine, preferably a primary amine.

18. The manufacturing method according to claim 17, wherein the functional group of the molecular switch is a succinimidyl ester.

19. The manufacturing method according to claim 13, further comprising connecting the heat exchange structure to heating means.
